(19) United States
(12) Patent Application Publication
(10) Pub. No.: US 2010/0233527 A1
(43) Pub. Date: Sep. 16, 2010

(54) BATTERY TERMINAL

(75) Inventors: John Eric Meschter, New York, NY (US); Henry M. Meehan, Suffern, NY (US)

Correspondence Address: DESIGN IP, P.C., 5100 W. TILGHMAN STREET, SUITE 205, ALLENTOWN, PA, 18104, US

(73) Assignee: INTERNATIONAL BATTERY, INC., Oakland, NJ (US)

(21) Appl. No.: 12/403,512

(22) Filed: Mar. 13, 2009

(51) Int. Cl. H01M 2/30; H01M 4/82; H01M 2/02

(52) U.S. Cl. 429/178; 29/623.1

(57) ABSTRACT

A battery terminal including a fastener shaft and a non-parallel slot, which when compressed by the use of a fastener such as a rivet, creates an autogenous spring force in a direction outward from the slot. When an electrode assembly is attached to the battery terminal, the autogenous spring force acts to create a more secure and reliable connection between the battery terminal and the electrode assembly.

### BACKGROUND OF THE INVENTION

This invention relates to battery terminals having application for lithium-ion cells or other types of batteries. Strong compression between a battery terminal and its accompanying electrode layers is important because it reduces the possibility of the battery terminal coming loose from the electrode layers over time, thereby preventing electrical resistance that might result from a loose terminal connection, and increasing the conductive quality of the battery. Establishment of a strong connection quality between battery terminals and accompanying electrode layers is particularly important in large-format batteries, where even small variations in conductivity can significantly affect the operation of the attached device.

Existing battery designs use bolted joints or rivets to secure battery terminals to the positive and negative electrodes (anodes and cathodes, respectively) of a battery. Connections using bolted joints have several drawbacks. First, the bolted connection may come loose if the battery is vibrated. In lithium ion battery designs, the terminals are preferably made from soft metals, such as aluminum and copper. For these metals, it is difficult to achieve high compression in bolted joints because the softness of these metals leads to thread stripping. The resulting loose connection will increase the electrical resistance between the electrodes and the terminal, thus causing the battery to heat up more quickly during charging and leading to deteriorated battery performance. Moreover, the use of harder metals is not preferred because using different types of metal in a terminal can result in galvanic corrosion and differential thermal expansion, further decreasing the connection quality between terminal and electrodes.

To overcome these drawbacks, recent battery designs have focused on the use of rivets of like metal to fasten electrodes to a battery terminal. The major drawback to the use of rivets alone is that they are incapable of creating sufficient compression between the battery terminal and the electrodes to effectively reduce the issues noted above. As a result, connection quality suffers due to spacing between the electrodes and the battery terminal. Therefore, there is a need for a cost-effective, secure, and reliable battery terminal that provides improved connection quality over existing designs.

### SUMMARY OF THE INVENTION

In one respect, the invention comprises a battery terminal, comprising: a post; a block in electrical communication with the post, the block having an external surface, a first end, and a second end that opposes the first end; a fastener shaft formed in the block and extending from the first end to the second end, the fastener shaft having a longitudinal axis; and a slot that extends from the external surface into the block and through at least a portion of the fastener shaft, the slot being non-parallel to the longitudinal axis.

In another respect, the invention comprises a battery cell, comprising: an electrode assembly including at least one electrode layer; a battery terminal having a post and a block in electrical communication with the post, the block having an external surface, a first end and a second end that opposes the first end, a fastener shaft formed in the block and extending from the first end to the second end, the fastener shaft having a longitudinal axis, and a slot that extends from the external surface into the block and that extends through at least a portion of the fastener shaft, the slot being oriented non-parallel to the longitudinal axis of the fastener shaft; and a fastener that extends through the fastener shaft, secures the electrode assembly to the block, and provides an electrical connection between the electrode assembly and the block.

In yet another respect, the invention comprises a method of attaching electrodes to a battery terminal having a block, the method comprising: positioning a plurality of electrode layers between an end of a fastener and the block; inserting the fastener into a fastener shaft formed in the block, the block including a slot formed therein that extends from an external surface through at least a portion of the fastener shaft; and installing a fastener through the block in a manner that compresses the slot and retains the plurality of electrode layers between the end of the fastener and the block.

### BRIEF DESCRIPTION OF THE DRAWINGS

The present invention will hereinafter be described in conjunction with the appended drawing figures wherein like numerals denote like elements.

FIG. 1 is a perspective view of a battery cell, shown with a portion of the case cut away;

FIG. 2 is an enlarged partial view of area 2 of FIG. 1;

FIG. 3 is a sectional view taken along line 3-3 of FIG. 2; and

FIG. 4 is a perspective view of a second embodiment of a battery terminal according to the present invention.

### DETAILED DESCRIPTION OF THE PREFERRED EMBODIMENTS

The ensuing detailed description provides preferred exemplary embodiments only, and is not intended to limit the scope, applicability, or configuration of the invention. Rather, the ensuing detailed description of the preferred exemplary embodiments will provide those skilled in the art with an enabling description for implementing the preferred exemplary embodiments of the invention. It being understood that various changes may be made in the function and arrangement of elements without departing from the spirit and scope of the invention, as set forth in the appended claims.

To aid in describing the invention, directional terms are used in the specification and claims to describe portions of the present invention (e.g., upper, lower, left, right, etc.). These directional definitions are merely intended to assist in describing and claiming the invention and are not intended to limit the invention in any way. In addition, reference numerals that are introduced in the specification in association with a drawing figure may be repeated in one or more subsequent figures without additional description in the specification in order to provide context for other features.

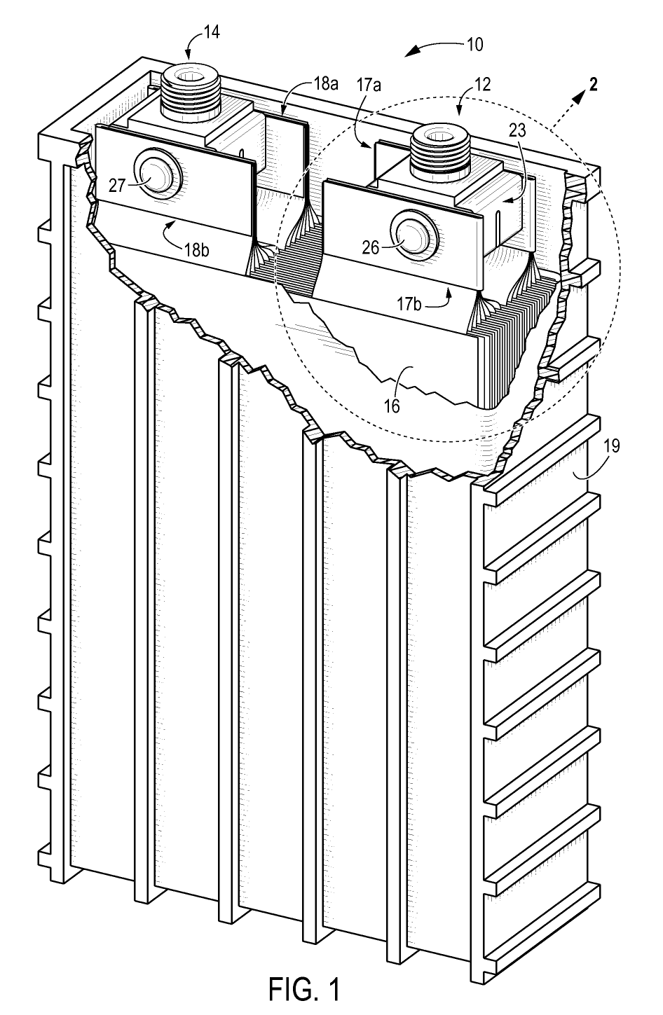

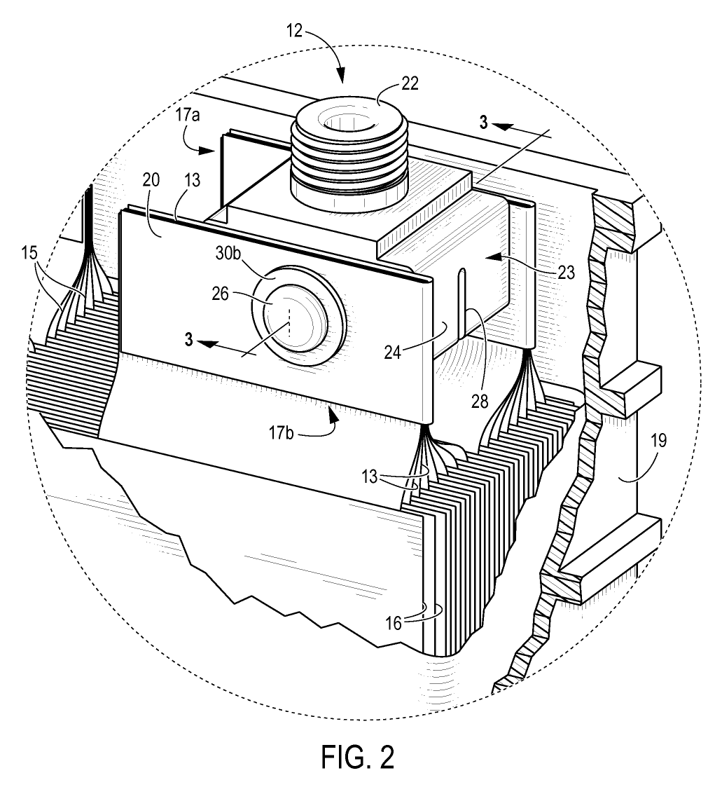

FIG. 1 illustrates one embodiment of a battery cell 10. In this embodiment, the battery cell 10 is a lithium ion cell, though it should be understood that the present invention may be utilized in other types of batteries. The battery cell 10 has an anode 12 constructed of copper and a cathode 14 constructed of aluminum. An alternating series of anode layers 13 and cathode layers 15 (see FIG. 2) are arranged with a separator 16 between each electrode layer 13, 15. In this embodiment, the anode layers 13 are made of copper and the cathode layers 15 are made of aluminum. The anode layers 13, cathode layers 15, and separators 16 are submerged in an electrolyte bath (not shown) within a case 19. In this embodiment, the anode layers 13 are collected into two anode electrode assemblies 17a, 17b and the cathode layers 15 are collected into two electrode assembles 18a, 18b. Because the electrode assemblies 17a, 17b, 18a, 18b are substantially identical in construction, reference will be made hereinafter to the structure of anode electrode assembly 17a.

The anode 12 is connected to the anode electrode assemblies 17a, 17b by means of a rivet 26, which, in this embodiment, is made of copper. It should be understood that any type of suitable fastener could be used instead of a rivet, such as for example a bolt, machine screw, or set screw, with a nut where necessary. The cathode 14 is connected to the cathode electrode assemblies 18a, 18b by means of a rivet 27, which, in this embodiment, is made of aluminum. The use of the same metal for all components of the anode 12 and cathode 14, respectively, is preferred in order to avoid differential thermal expansion and minimize galvanic corrosion. Other than being constructed of different metals, however, it should be understood that the anode 12 and cathode 14 in this embodiment are identical in structure. Therefore, in the interest of brevity, anode 12 will be described herein in detail and it should be understood that cathode 14 and anode 12 are identical in structure.

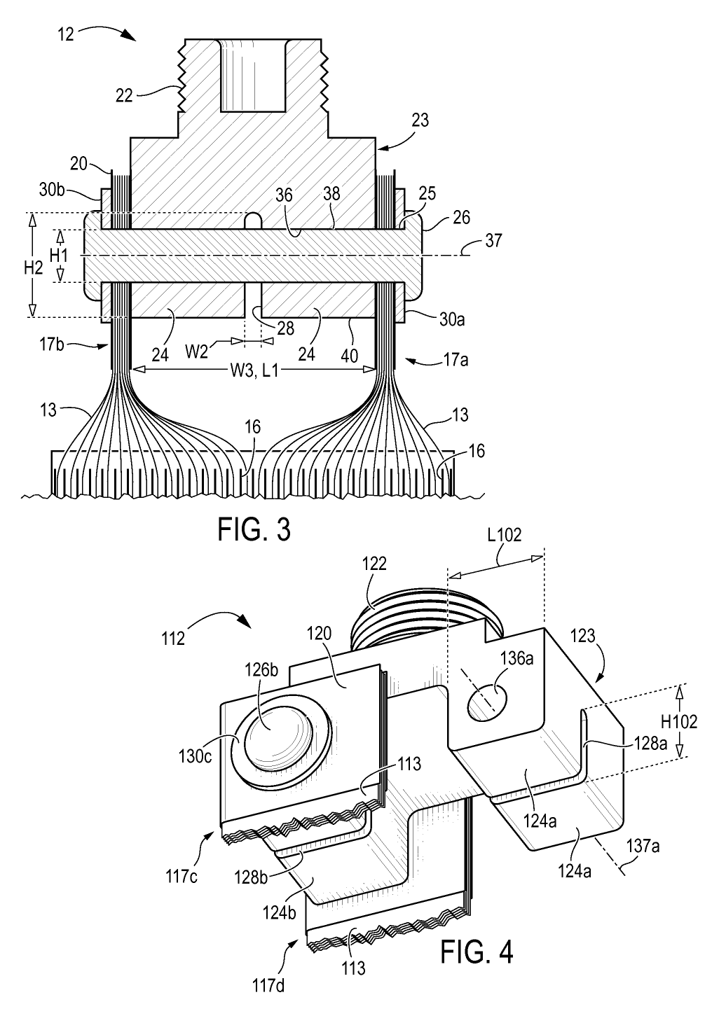

Referring to FIGS. 2 and 3, the anode 12 has a terminal body 23 connected to a post 22, a block 24 that is in electrical communication with the post 22, and a slot 28. In this embodiment, the post 22 is a threaded protrusion that is designed to engage a conducting wire or connect directly with another device. It should be understood, however, that the post 22 may be of any suitable design.

In this embodiment, the block 24 descends from the terminal body 23 in a direction opposite the post 22. It should be understood, however, that any number of block/post configurations are possible. The block 24 has a fastener shaft 36 (see FIG. 3) having a longitudinal axis 37 extending through the block 24. The anode electrode assembly 17a has a hole 25 (see FIG. 3) which is aligned with the fastener shaft 36. This hole 25 may be created at any point in the production process, but it is most efficient to first collect the anode layers 13, and then to drill a single hole through the anode electrode assembly 17a. In the alternative, the anode layers 13 and the anode electrode sleeve 20 could be pre-fabricated with aligning holes, and then assembled into an anode electrode assembly 17a.

An anode electrode sleeve 20 could be used to collect and hold the anode layers 13. The anode electrode sleeve 20 is preferably thicker than the anode layers 13 that it collects and retains. The anode electrode sleeve 20 provides protection against tearing of the anode layers 13, and is also used to condense the anode layers 13 for increased connection quality.

The anode 12 of the present embodiment is constructed in the following manner. First, the terminal body 23, having block 24 and being in electrical communication with post 22, is fabricated. Then the fastener shaft 36 is drilled through the block 24. The slot 28 is then cut from the lower external surface 40 of the block 24 through a point above the fastener shaft 36. Although in this embodiment the fastener shaft 36 and slot 28 are created in a terminal body 23 that is solid, it should be understood that either or both of the slot 28 and fastener shaft 36 may be pre-fabricated as part of the terminal body 23. In either case, the invention is easily manufactured using standard machine apparatuses, at a low cost to the producer.

The anode 12 is then integrated into the battery cell 10 of the present embodiment in the following manner. First, anode layers 13 are collected in the anode electrode sleeve 20 to create the anode electrode assembly 17a. A hole 25 is then drilled through the anode electrode assembly 17a. Although in the present embodiment the hole 25 is drilled after assembling the anode electrode assembly 17a, it should be understood that the hole 25 may be pre-drilled in the anode layers 13 or anode electrode sleeve 20, or the hole 25 may be pre-fabricated as part of the design of the anode layers 13 and the anode electrode sleeve 20.

The anode electrode assembly 17a is then aligned with the fastener shaft 36. In the present embodiment, two anode electrode assemblies 17a, 17b are used, each being aligned with an opposite end of the fastener shaft 36. To attach the anode 12, the rivet 26 is inserted through the washer 30a, anode electrode assembly 17a, fastener shaft 36, anode electrode assembly 17b, and washer 30b, in that order. It should be understood, however, that many other connection arrangements are possible, such as where the washers 30a, 30b are omitted, additional washers are included at various locations along the length of the rivet 26, or multiple anode electrode assemblies are attached on one or both sides of the anode 12. In the present embodiment, washers 30a, 30b are flat washers. Flat washers are preferable due to their low cost and ready availability. It should be understood, however, that other types of washers may be used, including but not limited to fender, split lock, dock, square, and external and internal tooth lock types.

The block 24 is then compressed in a direction substantially parallel to the longitudinal axis 37 of the fastener shaft 36 by means of a clamp, press, or other suitable means. Compression of the block 24 in a direction substantially parallel to the longitudinal axis 37 of the fastener shaft 36 compresses the slot 28, thereby creating an autogenous spring force in both outwardly directions (i.e. along the longitudinal axis 37 of the fastener shaft 36). The rivet 26 is then fixed in place using a rivet machine or other suitable means. For example, the Orbitform rivet machine, produced by Orbitform Group, L.L.C. of Jackson, Mich., may be used to fix the rivet 26. It should be understood that, in the alternative, the block 24 may also first be compressed, then the anode electrode assemblies 17a, 17b and washers 30a, 30b aligned with the fastener shaft 36, before insertion and fixation of the rivet 26. It is preferable, as in the present embodiment, that the rivet 26 be adapted to snugly fit within fastener shaft 36. Alternatively, the diameter of fastener shaft 36 may be larger than the diameter of rivet 26, or fastener shaft 36 may be of non-cylindrical shape.

FIG. 3 illustrates an orthogonal view of the anode 12, with a cut-away portion providing a sectional view of the rivet 26 installed in the fastener shaft 36. In the present embodiment, slot 28 is shown extending from the lower external surface 40 of the block 24 beyond the fastener shaft 36 (i.e. to a point between the post 22 and the top 38 of the fastener shaft 36). The height H1 and length L1 of the fastener shaft 36 (measured along its longitudinal axis 37), and the height H2 and width W2 of the slot 28, are shown in FIG. 3.

The slot 28 height H2, width W2, location with respect to the width W3 of the block 24, and relative orientation with respect to the longitudinal axis 37 of the fastener shaft 36 are attributes affecting the functionality of the invention. It is preferable that the height H2 of the slot 28 extend from the lower external surface 40 of the block 24 to at least halfway through the height H1 of the fastener shaft 36. More preferably, the height H2 of the slot 28 would extend to the top 38 of the fastener shaft 36. Most preferably, as seen in the present embodiment, the height H2 of the slot 28 extends past the top 38 of the fastener shaft 36, which allows for maximum compression of the block 24. In the present embodiment, the portion of the height H2 of the slot 28 that extends above the top 38 of the fastener shaft 36 represents between 10-15% of the overall height H2 of the slot 28.

Another way of describing the preferred configuration of the slot 28 is to describe the slot 28 as overlapping a cross-section of the fastener shaft 36. Under this description, it is preferable that the slot 28 extend through at least half of a cross section of the fastener shaft, more preferably, through an entire cross section of the fastener shaft 36 and most preferably, extends beyond the fastener shaft 36. In this embodiment, where the slot 28 is orthogonal to the longitudinal axis 37 of the fastener shaft 36 and is orthogonal to the width W3 of the block 24 and the fastener shaft 36 is cylindrical, the cross section of the fastener shaft 36 that is intersected by the slot 28 is circular.

The width W2 of the slot 28 is preferably in the range of 1%-25% of the overall width W3 of the block 24. More preferably, the width W2 of the slot 28 is in the range of 2%-10% of the overall width W3 of the block 24. Most preferably, as in the present embodiment, the width W2 of the slot 28 is in the range of 4%-8% of the overall width W3 of the block 24. The optimal width W2 of the slot 28 may be affected by the elastic qualities of the metal used for the anode 12 or cathode 14 constructions. Aluminum metal, for example, is generally softer than copper metal. Accordingly, a slot 28 having a larger width W2 or length L2 (not shown) may be necessary in a cathode 14 made of aluminum to generate an equivalent autogenous spring force to that created by an anode 12 made of copper having a slot 28 with a smaller width, but otherwise being of equivalent dimensions, arrangement, and make.

It is preferable that the slot 28 be positioned within the middle 50% of the width W3 of the block 24. Even more preferably, the slot 28 will be located within the middle 25% of the width W3 of the block 24. Most preferably, as in the present embodiment, the slot 28 is located at the midpoint of the width W3 of the block 24. Central positioning of the slot 28 within the width W3 of the block 24 is most preferable because compression of the block 24 then results in an equivalent spring force being applied in both outwardly directions (i.e. along the longitudinal axis 37 of the fastener shaft 36) towards the electrode assemblies 17a, 17b. This equivalent spring force provides a more stable connection between the block 24 and the electrode assembly 17a.

In this embodiment, the slot 28, along its axes of both height H2 and length L2 (measured from the front to the back of the block 24 of FIG. 3, but not shown), is oriented substantially orthogonal to the longitudinal axis 37 of the fastener shaft 36. It is preferable to have such an orthogonal orientation in order to maximize the compressive spring force generated by the block 24 when it is compressed. It should be understood, however, that a non-parallel orientation of the slot 28 (along its height H2 and length L2 axes) relative to the longitudinal axis 37 of the fastener shaft 36 could be used.

In a preferred embodiment, the slot 28 is oriented orthogonal to the longitudinal axis 37 of the fastener shaft 36, and extends from the lower external surface 40 of the block 24 past the top 38 of the fastener shaft 36. In this embodiment, the slot 28 extends through a cylindrical cross-section of the longitudinal axis 37 of the fastener shaft 36, with the height of the cylindrical cross-section being the width W2 of the slot 28. In alternative embodiments, where the slot 28 is not orthogonal to the longitudinal axis 37 of the fastener shaft 36, the shape created by the slot 28 that extends at least halfway into, through, or beyond a cross-section of the fastener shaft 36 is an oblique cylinder (or a portion thereof where the slot 28 does not extend entirely through the fastener shaft 36).

It is also within the scope of this invention that multiple slots (not shown) could be present in a block 24. If multiple slots are present in a block 24, it is most preferable that the multiple slots be parallel to each other, in order to maximize the autogenous spring force generated by the block 24 when it is compressed. It should be understood, however, that any non-orthogonal relative orientation of multiple slots within a block 24 could be used.

It is most preferable that slot 28, along its axes of both height H2 and length L2, be oriented substantially orthogonal to the longitudinal axis 37 of the fastener shaft 36, in order to maximize the amount of compressive spring force that is generated when the block 24 is compressed. It should be understood, however, that any non-parallel relative orientation of the slot 28 and the longitudinal axis 37 of the fastener shaft 36 will achieve an autogenous spring force in a direction parallel to the longitudinal axis 37 of the fastener shaft 36 when the rivet 26 is installed in the block 24 while it is compressed. Fixation of the rivet 26 when the block 24 is in a compressed state maintains a constant, reliable, and permanent autogenous spring force in an outwardly direction from the slot 28 along the longitudinal axis 37 of the fastener shaft 36.

The presence of the slot 28 also improves the functioning of a nut and bolt where they are used in conjunction as the fastener. In a battery terminal having a solid block, the compressibility of the block is minimal, so that the attached nut can undergo very little angular rotation on the bolt from the point which it first contacts the block until it is tightened against the block. With the presence of the slot 28 in the block 24, the nut will travel through far more angular rotation on the bolt from the point which it first contacts the block until it has tightened. This results in a far tighter connection than is possible with an unslotted block. This increased tightness decreases the possibility that the nut will come loose from the bolt, thereby increasing the reliability of the connection.

In this embodiment, the autogenous spring force acts outwardly from the slot 28 upon the block 24, anode electrode assemblies 17a, 17b, washers 30a, 30b, and the ends of the rivet 26, which is fully installed. The autogenous spring force increases the compressive force between the anode electrode assemblies 17a, 17b and the block 24. This increased compressive force results in a decreased amount of connection resistance, and provides a more intimate and reliable construction for the anode 12.

FIG. 4 illustrates a perspective view of a second embodiment of an anode 112 according to the present invention. In this embodiment, elements shared with the first embodiment (anode 12) are represented by reference numerals increased by factors of 100. For example, the post 22 in FIGS. 1-3 corresponds to the post 122 in FIG. 4. In the interest of brevity, some features of this embodiment that are shared with the first embodiment are numbered in FIG. 4, but are not repeated in the specification.

FIG. 4 shows an alternative embodiment of the anode 112 having two blocks 124a, 124b, each in electrical communication with the post 122. This embodiment is intended to be used in larger battery cell designs where the first embodiment would be insufficient. Block 124a has a slot 128a and a fastener shaft 136a through which a rivet 126a (not shown) is extended to engage anode electrode assemblies 117a (not shown) and 117b (not shown). Block 124b has a slot 128b and a fastener shaft 136b (not shown) through which a rivet 126b is extended to engage anode electrode assemblies 117c and 117d. In the alternative, a single electrode assembly could be attached on each side of the anode 112, so that both blocks 124a, 124b engage each of the two electrode assemblies on either side of the anode 112. In the present embodiment, it should be understood that the blocks 124a, 124b are identical in structure. Therefore, in the interest of brevity, block 124a will be further described in detail, and it should be understood that such description also applies to block 124b.

Slot 128a in block 124a is oriented orthogonal, along both its axes of height H102 and length L102, to the longitudinal axis 137a of the fastener shaft 136a, though it should be understood that any non-parallel relative orientation of the slot 128a and the longitudinal axis 137a of the fastener shaft 136a is acceptable.

While the principles of the invention have been described above in connection with preferred embodiments, it is to be clearly understood that this description is made only by way of example and not as a limitation of the scope of the invention.

1. A battery terminal, comprising:
a post;
a block in electrical communication with the post, the block having an external surface, a first end, and a second end that opposes the first end;
a fastener shaft formed in the block and extending from the first end to the second end, the fastener shaft having a longitudinal axis; and
a slot that extends from the external surface into the block and through at least a portion of the fastener shaft, the slot being non-parallel to the longitudinal axis.

2. The battery terminal of claim 1, wherein the slot is orthogonal to the longitudinal axis.

3. The battery terminal of claim 1, wherein the slot extends from the external surface of the block through at least half of a cross section of the fastener shaft.

4. The battery terminal of claim 1, wherein the slot extends from the external surface of the block through an entire cross section of the fastener shaft.

5. The battery terminal of claim 1, wherein the slot extends from the external surface of the block through a cross section of the fastener shaft and to a position of the block that is beyond the fastener shaft.

6. The battery terminal of claim 1, wherein the block has a width that is parallel to the longitudinal axis and a length that is orthogonal to the longitudinal axis, and the slot extends across the entire length of the block.

7. The battery terminal of claim 1, wherein the block has a width that is parallel to the longitudinal axis and a length that is orthogonal to the longitudinal axis, and the slot is located within the central 50 percent of the width of the block.

8. The battery terminal of claim 1, wherein the block has a width that is parallel to the longitudinal axis and a length that is orthogonal to the longitudinal axis, and the slot is located within the central 25 percent of the width of the block.

9. The battery terminal of claim 1, wherein the fastener shaft has a longitudinal axis and the block has a width that is parallel to the longitudinal axis and a length that is orthogonal to the longitudinal axis, and the slot bisects the width of the block.

10. A battery cell, comprising:
an electrode assembly including at least one electrode layer;
a battery terminal having a post and a block in electrical communication with the post, the block having an external surface, a first end and a second end that opposes the first end, a fastener shaft formed in the block and extending from the first end to the second end, the fastener shaft having a longitudinal axis, and a slot that extends from the external surface into the block and that extends through at least a portion of the fastener shaft, the slot being oriented non-parallel to the longitudinal axis of the fastener shaft; and
a fastener that extends through the fastener shaft, secures the electrode assembly to the block, and provides an electrical connection between the electrode assembly and the block.

11. The battery cell of claim 10, further comprising a second electrode assembly secured to the opposite side of the block from the electrode assembly, the second electrode assembly being comprised of at least one electrode layer, the second electrode assembly being in electrical connection with the block.

12. The battery cell of claim 10, wherein the slot is orthogonal to the longitudinal axis of the fastener shaft.

13. The battery cell of claim 10, wherein the slot extends from the external surface of the block through at least half of a cross section of the fastener shaft.

14. The battery cell of claim 10, wherein the slot extends from the external surface of the block through an entire cross section of the fastener shaft.

15. The battery cell of claim 10, wherein the slot extends from the external surface of the block through a cross section of the fastener shaft and to a position of the block that is beyond the fastener shaft.

16. The battery cell of claim 10, wherein the block has a width that is parallel to the longitudinal axis and a length that is orthogonal to the longitudinal axis, and the slot extends across the entire length of the block.

17. The battery cell of claim 10, wherein the block has a width that is parallel to the longitudinal axis and a length that is orthogonal to the longitudinal axis, and the slot is located within the central 25 percent of the width of the block.

18. The battery cell of claim 10, wherein the block has a width that is parallel to the longitudinal axis and a length that is orthogonal to the longitudinal axis, and the slot bisects the width of the block.

19. The battery cell of claim 10, wherein the fastener is a rivet.

20. A method of attaching electrodes to a battery terminal having a block, the method comprising:
positioning a plurality of electrode layers between an end of a fastener and the block;
inserting the fastener into a fastener shaft formed in the block, the block including a slot formed therein that extends from an external surface through at least a portion of the fastener shaft; and
installing a fastener through the block in a manner that compresses the slot and retains the plurality of electrode layers between the end of the fastener and the block.
